(19) United States
(12) Patent Application Publication
(10) Pub. No.: US 2022/0039585 A1
(43) Pub. Date: Feb. 10, 2022

(54) Pressure Cooker Having Temperature Probe

(71) Applicant: Hamilton Beach Brands, Inc., Glen Allen, VA (US)

(72) Inventors: Suzanne Hensley, Chesterfield, VA (US); George W Stamper, III, Quinton, VA (US); Derek A McCullough, Richmond, VA (US)

(21) Appl. No.: 16/986,414

(22) Filed: Aug. 6, 2020

(51) Int. Cl. A47J 27/08; A47J 27/086; A47J 27/09

(52) U.S. Cl. CPC A47J 27/0802; A47J 27/09; A47J 27/086

(57) ABSTRACT

A pressure cooker includes: a base configured to provide heat to an internal chamber for pressure cooking; a lid that engages the base to seal the chamber; a controller that controls one or more operational parameters of the pressure cooker, the controller located external to the internal chamber; and a temperature probe, the temperature probe comprising a temperature sensor positioned in the internal cavity, the temperature probe configured to communicate temperature signals to the controller.

### FIELD OF THE INVENTION

This invention relates generally to cooking appliances and, more particularly, to pressure cookers.

### BACKGROUND

Pressure cookers operate by increasing the pressure during cooking so as to allow food to more quickly absorb moisture and therefore cook more quickly. In order to increase pressure, pressure cookers increase the heat of a sealed internal chamber containing the food, causing the existing gas to expand, without the need to pump additional gas into the vessel.

After the pressure cooker has finished cooking food, cookers known in the art commonly allow release of the internal pressure in three different ways. First, pressure cookers may utilize a “natural release,” in which the vessel is allowed to gradually cool down, thereby allowing the gas inside to contract until the pressure subsides. As an alternative, pressure cookers may allow for a “quick release” option. A quick release typically involves opening a vent on the cooker to allow pressurized gases to quickly escape from the internal chamber, often in the form of steam. Some pressure cookers may also use a combination of the natural and quick release, allowing gas to escape from the internal chamber of the cooker at intermittent intervals.

Many pressure cookers known in the prior art require the user to monitor the cooker in order to either turn off the heat or release the gas when the user wants the cooking to stop, depending on which release method is being used. However, requiring users to actively monitor the cooker may be inconvenient, as it may prevent users from performing other tasks while the cooking is occurring and may increase the risk of overcooking or undercooking the food.

One of the key challenges users of pressure cookers face is not knowing if their food is fully cooked since there no access to the food while the pressure cooker is pressurized. In order to check the food, the user would have to release the pressure to a sufficient level that the pressure cooker can be opened safely and then re-pressurized, if needed, to complete cooking. As such, users tend to overcook the food instead going through the process of checking. If they find the food is nevertheless undercooked when the pressure cooker is opened, the users tend to finish the food in an oven or microwave or on a stovetop rather go through the process of re-pressurizing the pressure cooker.

Therefore, a pressure cooker which provides users with flexibility in creating or monitoring cooking conditions and/or releasing pressure from the cooking vessel may be desirable.

### SUMMARY

As a first aspect, embodiments of the invention are directed to a pressure cooker. The pressure cooker comprises: a base configured to provide heat to an internal chamber for pressure cooking; a lid that engages the base to seal the chamber; a controller that controls one or more operational parameters of the pressure cooker, the controller located external to the internal chamber; and a temperature probe, the temperature probe comprising a temperature sensor positioned in the internal cavity, the temperature probe configured to communicate temperature signals to the controller.

As a second aspect, embodiments of the invention are directed to a pressure cooker comprising: a base configured to provide heat to an internal chamber for pressure cooking; a lid that engages the base to seal the chamber; a controller that controls one or more operational parameters of the pressure cooker, the controller located external to the internal chamber; and a temperature probe, the temperature probe comprising a temperature sensor positioned within the internal chamber and a cable connected between the temperature sensor and the controller.

As a third aspect, embodiments of the invention are directed to a pressure cooker comprising: a base configured to provide heat to an internal chamber for pressure cooking; a lid that engages the base to seal the chamber, the lid including an opening; a controller that controls one or more operational parameters of the pressure cooker, the controller located external to the internal chamber; and a temperature probe, the temperature probe comprising a temperature sensor positioned within the internal chamber and a cable routed from the temperature sensor through the opening and to the controller, the temperature probe configured to communicate temperature signals to the controller. The pressure cooker further comprises a stopper unit attached to the lid, the stopper unit including a plug configured to be inserted into the opening to seal the opening in the absence of the temperature probe.

### BRIEF DESCRIPTION OF THE FIGURES

FIG. 1 is a top perspective view of a pressure cooker, according to embodiments of the invention.

FIG. 2 is a partial section view of the pressure cooker of FIG. 1, showing the temperature probe in the cooking cavity in broken line prior to insertion in the valve seat.

FIG. 3 is an enlarged partial section view of the pressure cooker of FIG. 2, with the temperature probe inserted into the valve seat.

FIG. 4 is an enlarged perspective view of the valve seat and stopper unit of the temperature probe of the pressure cooker of FIG. 1.

FIG. 5 is a side view of the valve seat and stopper unit of the pressure cooker of FIG.

FIG. 6 is a side section view of the valve seat and stopper unit of the pressure cooker of FIG. 1.

FIG. 7 is an enlarged partial side view of the stopper of the temperature probe of the pressure cooker of FIG. 1.

FIG. 8 is a perspective view of the temperature probe of the pressure cooker of FIG. 1.

FIG. 9 is a side section view of the stopper of the temperature probe of FIG. 8.

FIG. 10 is a side section view of the stopper unit and valve seat of FIG. 5 with the plug inserted in the opening in the valve seat.

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Like numbers refer to like elements throughout. In the figures, certain layers, components or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all technical and scientific terms that are used in this disclosure have the same meaning as commonly understood by one of ordinary skill in the art to which this invention belongs. The terminology used in the below description is for the purpose of describing particular embodiments only and is not intended to be limiting of the invention. As used in this disclosure, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “on,” “attached to,” “connected to,” “coupled with,” “contacting,” etc., another element, it can be directly on, attached to connected to, coupled with or contacting the other element or intervening elements may also be present. In contrast, when an element is referred to as being, for example, “directly on,” “directly attached to,” “directly connected to,” “directly coupled with,” or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “above”, “over”, “upper”, “lower”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

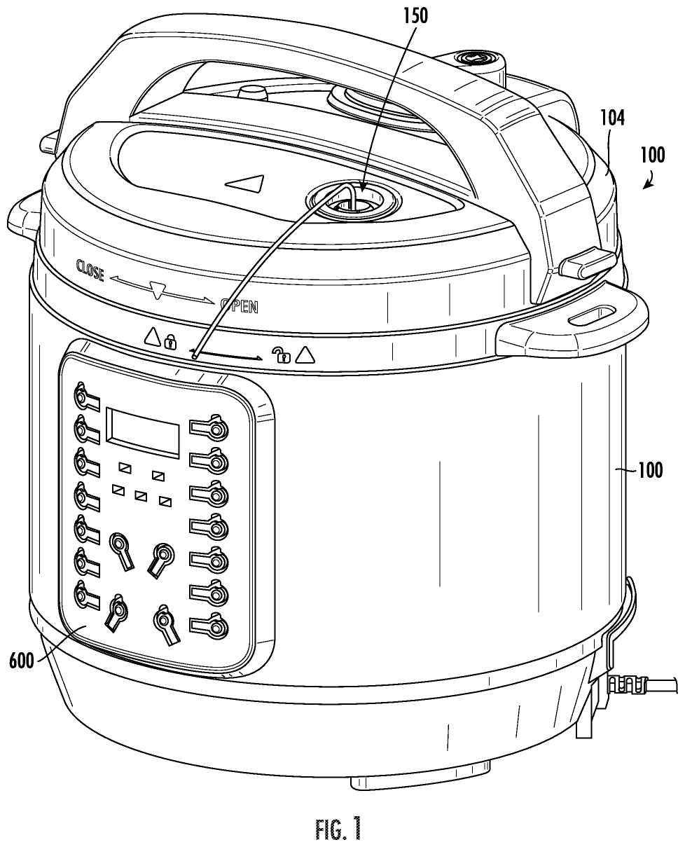

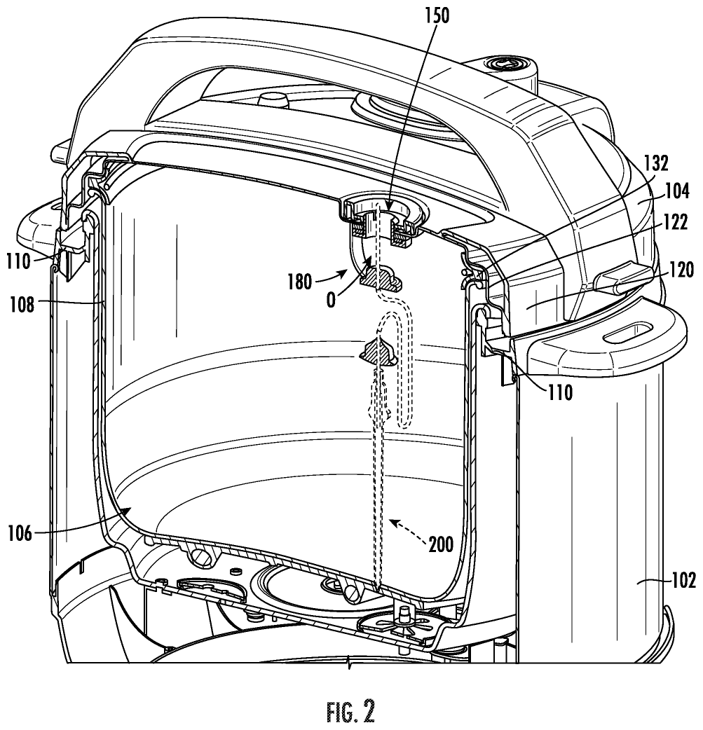

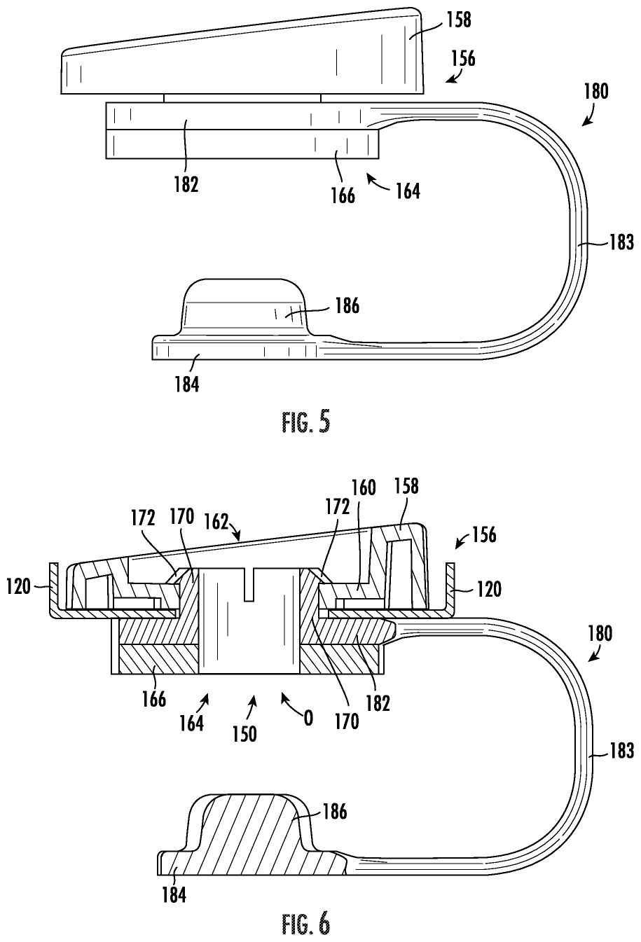

Referring now to the drawings, a pressure cooker, designated broadly at 100, is shown in FIGS. 1-6. The pressure cooker 100 comprises a base 102 and a lid 104. The base 102 includes various components conventionally found in pressure cookers, including one or more control dials, a heating element (not shown), a controller (shown schematically at 600 in FIG. 1) connected between the control dial(s) and the heating element, and the like. The controller 600 is configured to control one or more operational parameters, such as temperature, cooking time, activation (i.e., turning the pressure cooker 100 on or off), pressure release mode, or the like. The base 102 has one or more flanges 110 spaced about the periphery of the base 102 that are configured to interact with the lid 104. Together the base 102 and the lid 104 define an internal chamber 106 of the pressure cooker 100 (see FIG. 2). A separate pot 108 resides within the base 102.

Referring still to FIG. 2, the lid 104, which in the illustrated embodiment includes an outer cover 120 and an inner cover 122, has a surrounding gasket 132 that is attached to the underside of the inner cover 122 and is located to engage the upper edge of the pot 108. The gasket 132 seals the lid 104 against the upper edge of the pot 108. The lid 104 may be maintained in place in any number of ways.

Except as described below, the base 102, lid 104 and pot 108 are of conventional construction and may take many forms. An exemplary configuration is discussed in U.S. patent application Ser. No. 16/655,322, filed Oct. 17, 2019, the disclosure of which is hereby incorporated herein in its entirety.

As shown in FIGS. 1-3, the lid 104 includes an opening 150. A two-piece valve seat 152 fits within the opening 150 (the valve seat 152 is best seen in FIGS. 3-6). The valve seat 152 includes an upper base 156 that is generally circular, with an upstanding rim 158 extending from an annular base 160. A central hole 162 is present in the base 160. A lower fitting 164 is also circular, with a base 166 having a hole 168 and fingers 170 with hooks 172 that encircle the hole 168.

The valve seat 152 may be formed of many different materials, but in some embodiments is formed of a polymeric material. An exemplary polymeric material is polycarbonate.

Referring still to FIGS. 3-6, a stopper unit 180 includes a ring 182 located above the base 166 that encircles the fingers 170. A flexible arm 183 extends from the ring 182. At its free end, a disk 184 supports a plug 186. The stopper unit 180 may be formed of a number of different materials; exemplary materials include rubbers, such as silicone rubber.

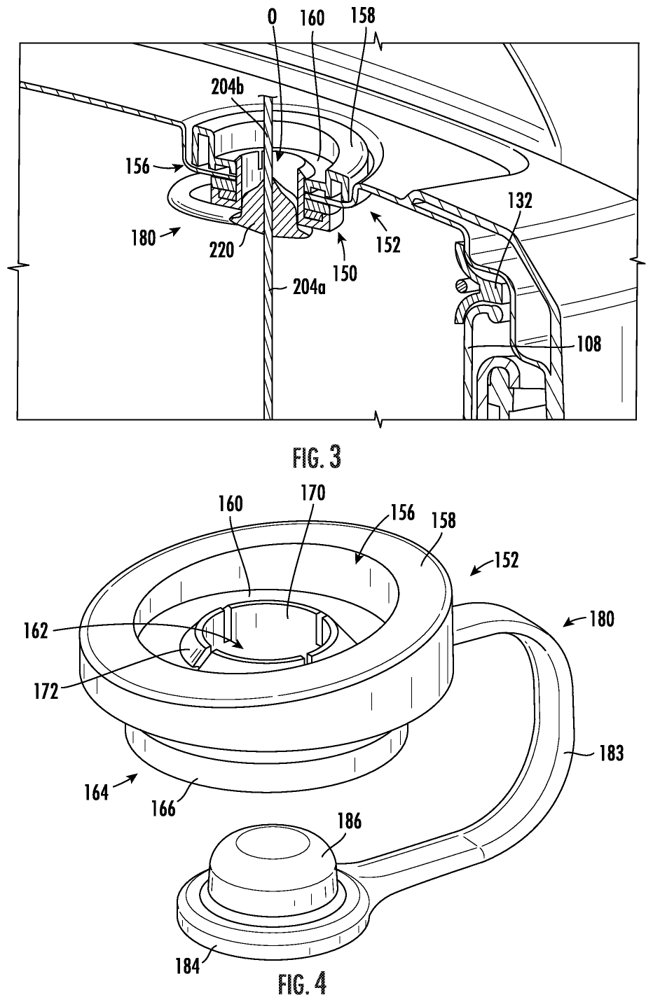

As seen in FIGS. 4-6, the ring 182 encircles the fingers 170. The fingers 170 are inserted through the opening 150 in the lid 104, such that the ring 182 of the stopper unit 180 abuts the lower surface of the lid 104. The upper base 156 is then lowered onto the fingers 170 from the upper side of the lid 104 so that the fingers 170 enter the hole 162 until that the hooks 172 engage the area of the base 160 adjacent the hole 162. As a result, the valve seat 152 is mounted to the lid 104 with the upper base 152 above the lid 104, the base 166 of the lower fitting 164 below the lid 104, the holes 162, 168 aligned to provide an opening O through the lid 104, and the ring 182 providing a seal between the stopper unit 180 and the lid 104.

As can be envisioned from FIGS. 5 and 10, the arm 182 of the stopper unit 180 is sufficiently flexible that the plug 186 of the stopper unit 180 can be positioned below the hole 168 of the lower fitting 164 to close the opening O and inserted into the hole 168. As such, the opening O in the lid 104 is sealed so that the internal chamber 106 is airtight under the pressure of the pressure cooker 100.

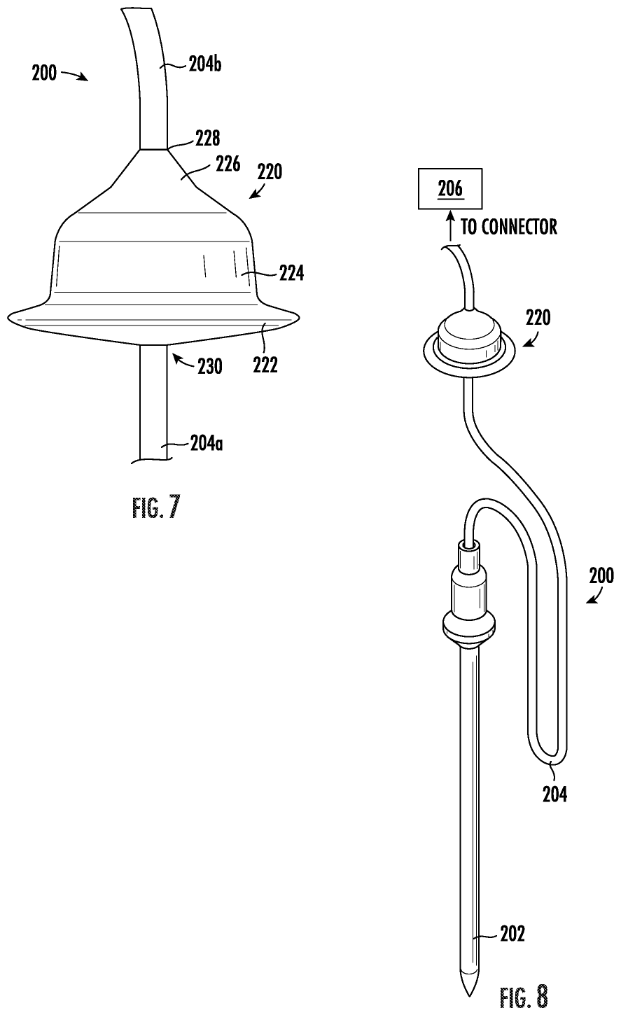

Referring now to FIGS. 7-9, a temperature probe unit, designated broadly at 200, is shown therein. The temperature probe unit 200 includes an elongate sensor 202 that is configured to be inserted into a foodstuff, a flexible cord 204, and a connector 206 that enables the temperature probe unit 200 to be connected with an external port (not shown), which may be, for example, mounted on the base 102 and operatively connected with the controller 600. Such connection can enable signals obtained by the sensor 202 to be transmitted to the controller 600. In some embodiments, the sensor 202 is between about 1 and 6 inches in length.

In addition, the temperature probe unit 200 includes a stopper 220. The stopper 220 is generally conical, with a lower flange 222, an intermediate section 224, and an upper section 226. As can be seen in FIG. 7, the intermediate section 224 is smaller in diameter than the lower flange 222 and has a relative steep cone angle A. The upper section 226 is smaller in diameter than the intermediate section 224, has a shallower cone angle B than the intermediate section 224, and narrows to a blunt end 228.

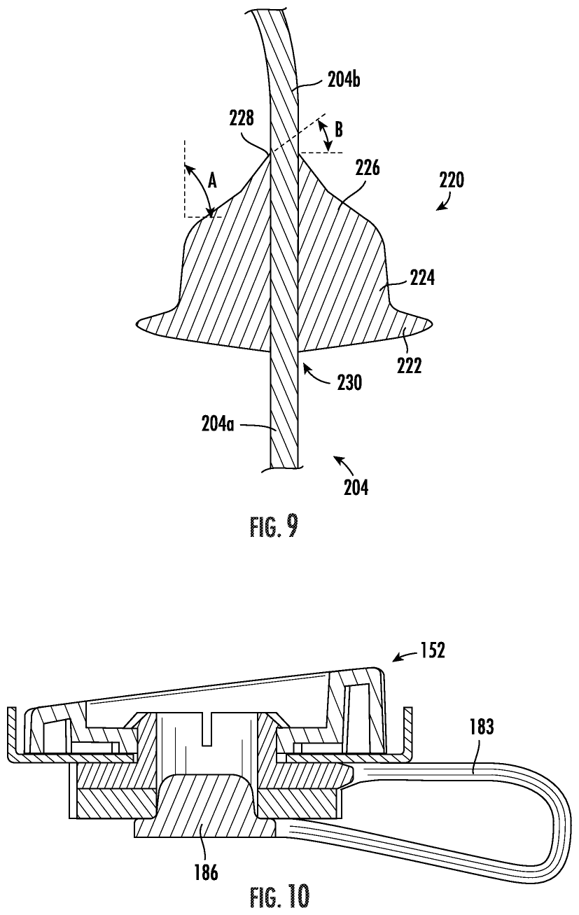

As can be seen in FIG. 9, the stopper 220 includes a bore 230 that snugly receives the cord 204. The stopper 220 is mounted to an intermediate portion of the cord 204, such that flexible sections 204a, 204b of the cord 204 are present on either side of the stopper 220. In some embodiments, the flexible section 204a may be between about 0 and 12 inches, and the flexible section 204b may be between about 1 and 18 inches.

As shown in FIG. 3, the temperature probe unit 200 can be positioned in the opening O, with the sensor 202, flexible section 204a and stopper 220 positioned below the lid 104 (i.e., within the chamber 106 when the lid 104 is in place on the base 102) and the flexible section 204b and connector 206 positioned above the lid 104 (i.e., outside the chamber 106 when the lid 104 is in place. The lower flange 222 and intermediate section 224 can combine to form an airtight seal between the stopper 220 and the lid 104.

Based on the foregoing, it can be seen that the pressure cooker 100 can be operated with the internal chamber 106 being pressurized whether the temperature probe 200 is employed or not. If the temperature probe 200 is not employed, the plug 186 is used to plug the opening O, the lid 104 is placed on the base 102 and secured into place, and pressurized cooking can commence.

If the temperature probe 200 is to be employed, the plug 186 is removed from the opening O, the section 204b of the cable 204 is routed through the opening O, and the stopper 220 is inserted into the opening O. The sensor 202 is inserted or immersed into the foodstuff within the internal chamber 106 for which the temperature is being monitored. The lid 104 is positioned on the base 102 and secured, and the connector 206 is connected with the controller 600 outside of the internal chamber 106. Cooking can then commence, with the controller 600 able to control one or more operational parameters based on the temperature signals communicated by the sensor 202. Exemplary operational parameters include temperature, cooking time, activation, and pressure release.

Notably, both the plug 186 and the stopper 220 are configured such that, when the internal chamber 106 of the pressure cooker 100 is heated and therefore becomes pressurized, such pressure (typically about 5-15 psi) forces the plug 186 or stopper 220 against the lower surface of the lid 104. As a result, when the internal chamber 106 is operating under pressure, the plug 186 and or stopper 220 can provide an even more airtight seal with the lid 104 to prevent the escape of air through the opening O.

Those of skill in this art will appreciate that other configurations may be suitable for use with pressure cookers according to embodiments of the invention. As one example, the pressure cooker 100 may have a stopper unit 180 that is not connected with the lid 104 (e.g., it may be connected with the bowl 108), or the stopper unit 180 may be detached entirely.

As another variant, the temperature probe 200 may be permanently mounted in the lid 104, such that the sensor 202 is always present in the internal chamber 106. In such an instance, there would be no need for a stopper unit 180. The controller 600 may be configured to either (a) disable the transmission of temperature signals from the sensor 202 or (b) ignore transmission of signals, should the user elect to cook without the need for temperature signals. In other embodiments, the temperature probe 200 may be permanently mounted to and routed through another structure of the pressure cooker 100 (e.g., through the bowl 108 and base 102 to the controller 106).

Moreover, those of skill in this art will appreciate that, in some embodiments, the temperature probe may be configured to provide signals to the controller wirelessly. As an example, a Radio protocol for signal transmission might be employed; alternately WiFi or BLUETOOTH protocols may be employed.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A pressure cooker, comprising:
a base configured to provide heat to an internal chamber for pressure cooking;
a lid that engages the base to seal the chamber;
a controller that controls one or more operational parameters of the pressure cooker, the controller located external to the internal chamber; and
a temperature probe, the temperature probe comprising a temperature sensor positioned in the internal cavity, the temperature probe configured to communicate temperature signals to the controller.

2. The pressure cooker defined in claim 1, wherein the temperature probe further comprises a cable connected with the controller.

3. The pressure cooker defined in claim 2, wherein the lid includes an opening, and wherein the cable is routed from the internal chamber through the opening to the controller.

4. The pressure cooker defined in claim 3, wherein the temperature probe further comprises a stopper mounted on the cable, and wherein the stopper is configured to be inserted into the opening to seal the opening.

5. The pressure cooker defined in claim 3, further comprising a valve seat that encircles the opening in the lid.

6. The pressure cooker defined in claim 5, further comprising a stopper unit attached to the valve seat, the stopper unit including a plug configured to be inserted into the opening to seal the opening.

7. The pressure cooker defined in claim 1, wherein the operational parameter controlled by the controller includes at least one of: temperature, cooking time, activation, and pressure release.

8. A pressure cooker, comprising:
a base configured to provide heat to an internal chamber for pressure cooking;
a lid that engages the base to seal the chamber;
a controller that controls one or more operational parameters of the pressure cooker, the controller located external to the internal chamber; and
a temperature probe, the temperature probe comprising a temperature sensor positioned within the internal chamber and a cable connected between the temperature sensor and the controller.

9. The pressure cooker defined in claim 8, wherein the lid includes an opening, and wherein the cable is routed from the internal chamber through the opening to the controller.

10. The pressure cooker defined in claim 9, wherein the temperature probe further comprises a stopper mounted on the cable, and wherein the stopper is configured to be inserted into the opening to seal the opening.

11. The pressure cooker defined in claim 9, further comprising a valve seat that encircles the opening in the lid.

12. The pressure cooker defined in claim 11, further comprising a stopper unit attached to the valve seat, the stopper unit including a plug configured to be inserted into the opening to seal the opening.

13. A pressure cooker, comprising:
a base configured to provide heat to an internal chamber for pressure cooking;
a lid that engages the base to seal the chamber, the lid including an opening;
a controller that controls one or more operational parameters of the pressure cooker, the controller located external to the internal chamber; and
a temperature probe, the temperature probe comprising a temperature sensor positioned within the internal chamber and a cable routed from the temperature sensor through the opening and to the controller, the temperature probe configured to communicate temperature signals to the controller; and
further comprising a stopper unit attached to the lid, the stopper unit including a plug configured to be inserted into the opening to seal the opening in the absence of the temperature probe.

14. The pressure cooker defined in claim 13, wherein the temperature probe further comprises a stopper mounted on the cable, and wherein the stopper is configured to be inserted into the opening to seal the opening.

15. The pressure cooker defined in claim 3, further comprising a valve seat that encircles the opening in the lid, and wherein the stopper unit is mounted on the valve seat.
